(19) United States
(12) Patent Application Publication
(10) Pub. No.: US 2023/0294906 A1
(43) Pub. Date: Sep. 21, 2023

(54) Method For Emptying Viscous Material Out Of A Cartridge That Is Open At Both Ends

(71) Applicant: dosmatix GmbH, Rohr (DE)

(72) Inventor: Erich Scheugenpflug, Neustadt/Donau (DE)

(21) Appl. No.: 18/200,485

(22) Filed: May 22, 2023

Related U.S. Application Data
(63) Continuation-in-part of application No. PCT/EP2021/081528, filed on Nov. 12, 2021.

(30) Foreign Application Priority Data
Nov. 24, 2020 (DE) 102020131081.1
Nov. 12, 2021 (WO) PCT/EP2021/081528

(51) Int. Cl. B65D 83/00; B05C 11/10

(52) U.S. Cl. CPC B65D 83/0005; B05C 11/1047

(57) ABSTRACT

An emptying device for emptying a viscous material in a bubble-free manner out of a removal opening of a cartridge involves extruding a plurality of thin strands of the material. The emptying device includes a collecting container mounted to a base frame and a cartridge carrier that moves in a pressing direction towards the base frame. A cartridge plunger is adapted to push a pusher of the cartridge in the pressing direction. A discharge drive drives the cartridge plunger. A distributing head divides the viscous material exiting the removal opening into the plurality of thin strands. The distributing head is fastened to the removal opening and is adapted to move axially in the collecting container in the pressing direction. A vacuum housing connects in an air-tight manner to the collecting container and to an outer circumference of the cartridge even while the cartridge moves relative to the first vacuum housing.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2021/081528, filed on Nov. 12, 2021, and published as WO 2022/112022 A1 on Jun. 2, 2022, which in turn claims priority from German Application No. 102020131081.1, filed in Germany on Nov. 24, 2020. This application is a continuation-in-part of International Application No. PCT/EP2021/081528, which is a continuation-in-part of German Application No. 102020131081.1. International Application No. PCT/EP2021/081528 is pending as of the filing date of this application, and the United States is an elected state in International Application No. PCT/EP2021/081528. This application claims the benefit under 35 U.S.C. § 119 from German Application No. 102020131081.1. The disclosure of each of the foregoing documents is incorporated herein by reference.

### TECHNICAL FIELD

The present disclosure relates to emptying highly viscous substances, i.e., paste-like material, out of supplied transport containers, especially cartridges, in a bubble-free manner.

### BACKGROUND

When processing highly viscous substances, e.g., in adhesive technology or the cosmetics industry, these substances or their individual components are delivered in transport containers such as cylindrical cartridges, which are generally made of plastic, with a capacity of one or more liters. The viscose material contained in the transport containers must be supplied from there to the consumer free of bubbles, i.e., without air pockets, using a doser or a mixer.

General references to cartridges in the present description are intended to encompass all transport containers that are open at both ends, but are closable, and that include a pusher that is moved inside the container tightly along the inner circumference of the cylindrical cartridge. The pusher is introduced from a rear end of the cartridge, while the opposite front end generally has a much smaller removal opening that is closed during transportation and can be opened for removal of the material.

The removal from the cartridge and the transport via a supply line (the discharge line) to the remote consumer is to be carried out as required and automatically without any time-consuming manual reworking. The emptying of the usually quite expensive materials is to be possible with as little remaining residue as possible. In addition, no air should be able to reach the material during emptying, or even air still contained in the material should be able to escape.

So far, this is attempted by inserting a degassing nozzle between the discharge line, usually a hose line, to be connected to the removal opening, and the removal opening, to which negative pressure can be applied. However, by this method, only gas bubbles can be removed that appear after opening of the removal opening and connection to the discharge line, but not gas bubbles that are, for example, finely distributed inside the material.

In general, it is known to degas fluid materials in a thin-layer process:

In this process, the material is guided over a surface in the form of a layer as thin as possible, thereby massively increasing the surface area of the flowing material, so that the probability of a contained gas bubble coming into contact with the surface of the layer and thus outgassing from the material is largely increased.

Furthermore, when removing barrels with viscous material, which are delivered as transport containers, it is known to empty such a barrel by way of a barrel follower plate placed on the material, but, already prior to inserting the barrel follower plate into the barrel and placing it onto the material, to apply negative pressure, in particular a vacuum, to the space around it and for this purpose, arrange a pressure-tight housing around it that includes a negative pressure connection.

However, due to the lack of a second opening, the material is conveyed out of a single opening at the top of the barrel, namely through the hollow piston rod attached to the barrel follower plate and pressing it downwards.

For this purpose, the barrel follower plate must be pressed against the material with high pressure, for which the stability of the barrel itself in a radial direction quite often is insufficient, but the barrel must be held together radially in a corresponding support device.

In the case of cartridges, the material is to be pressed out by means of the pusher located therein, which can be moved along a mostly round inner cross-section that is constant in a main extension direction of the cartridge, through the discharge opening provided in the opposite end face of the cartridge.

It is therefore an object of the present invention to provide a method for emptying cartridges in a bubble-free manner, by way of which also gas bubbles can be removed that exist inside the material prior to delivery to a consumer. Moreover, it is an object to provide an emptying device suited for this.

### SUMMARY

To empty a cartridge in a bubble-free manner, a viscous material is pressed out of a removal opening of the cartridge into a large-surface distributing head that has a plurality of small outlet openings on its lower side such that a plurality of thin strands of the viscous material are produced. The strands have a very large surface area in comparison to their volume. So that gas that is outgassed in the process can be removed, a vacuum is applied about the strands. The strands fall into a collecting container disposed underneath. After the cartridge is completely emptied, the viscous material is transported from the collecting container via an outlet opening disposed in the bottom of the collecting container and into a discharge line that is connected to a consumer of the viscous material. The discharge line can be connected to a doser. The viscous material can be forced out of the outlet opening by pressing the distributing head downward into the open side of the collecting container.

An emptying device for emptying a viscous material in a bubble-free manner out of a removal opening of a cartridge involves extruding a plurality of thin strands of the material. The emptying device includes a collecting container mounted to a base frame and a cartridge carrier that is guided in a pressing direction towards the base frame. The cartridge carrier is adapted to hold the cartridge. A cartridge plunger is adapted to push a pusher of the cartridge in the pressing direction. A discharge drive drives the cartridge plunger. A distributing head divides the viscous material exiting the removal opening into the plurality of thin strands that travel downwards in straight lines from the distributing head. The distributing head is fastened to the removal opening and is adapted to move axially in the collecting container in the pressing direction. A first vacuum housing connects in an air-tight manner to the collecting container and to an outer circumference of the cartridge even while the cartridge moves relative to the first vacuum housing. A second vacuum housing is disposed inside the cartridge carrier and connects in an air-tight manner to the outer circumference of the cartridge. The cartridge plunger passes through the second vacuum housing in an air tight manner.

A method for emptying viscous material in a bubble-free manner out of a cartridge involves extruding a plurality of thin strands of the viscous material. A pusher connected to a cartridge plunger is axially pushed through the cartridge in a pressing direction towards a removal opening of the cartridge. The pusher fits tightly in the cartridge. The viscous material is pressed out of the removal opening and through a distributing head such that the viscous material is divided into the plurality of thin strands. The plurality of thin strands are collected in a collecting container to which a discharge line is connected. A negative pressure is maintained in the collecting container while the plurality of thin strands are being collected in the collecting container. The negative pressure is a vacuum with a residual pressure inside the collecting container of at most 50 mbar. A negative pressure is also maintained in the cartridge behind the pusher while the viscous material is being pressed out of the removal opening. After the plurality of thin strands have been collected in the collecting container, the viscous material is pressed out of the collecting container through the discharge line by pushing the distributing head as a discharge piston axially down into the collecting container.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A is a perspective view of the emptying device according to the invention.

FIG. 1B and FIG. 1C are side views of the emptying device of FIG. 1A in a first and second transverse direction.

FIG. 2A shows the emptying device as seen in the second transverse direction in a vertical cross-section, with the pressing head above the hooked-in cartridge.

FIG. 2B shows the emptying device viewed in the first transverse direction and cut in a pressing direction, with the press head resting against the pusher and inside the cartridge.

FIG. 3A is a vertical cross-section of FIG. 2A, but with the distributing head as a discharge piston retracted in the collecting container.

FIG. 3B shows the emptying device in the same operating position, viewed in the same direction as the view of FIG. 2B.

FIG. 4A is a longitudinal cross-section through a full cartridge in the delivery state.

FIG. 4B is a longitudinal cross-section of a cartridge with the distributing head attached to the removal opening.

FIG. 4C is a perspective representation of the distributing head.

FIG. 5 is a principle representation of a dosing unit.

FIG. 6A, FIG. 6B and FIG. 6C illustrate the insertion of the cartridge into the emptying device.

### DETAILED DESCRIPTION

Reference will now be made in detail to some embodiments of the invention, an example of which is illustrated in the accompanying drawing.

With regard to the novel method, the object is solved in that in pressing out the material from the removal opening by means of axial displacement of a pusher, the material is divided into a plurality of thin strands. As a result of the large increase in surface area, the probability that a gas bubble in the material coming into contact with the surface of such a thin strand is much higher, and, of course, the higher the thinner the strands are. The strands are dropped into a collecting container open to the top and mix with the fluid material provided therein, which is delivered from the collecting container to a consumer by way of a main feed pipe connected to the lower part of the container.

In order to prevent new gas pockets from forming when the thin strands are combined with the material in the collecting container, at least the area where the material is divided into a large number of thin strands, i.e., approximately from the removal opening to the upper open end of the collecting container, is held under negative pressure during the emptying process of the cartridge, and preferably also during discharge of the material from the collecting container to a consumer.

The gas contained in an opening gas bubble in the material is then discharged from this area and, if there is nearly a vacuum in the area, no new gas pockets can form. Negative pressure within the context of the present description is understood to mean that this is in particular approximately a vacuum with a residual pressure of 50 mbar at most, preferably 10 mbar at most, further preferably 1 mbar at most.

For transportation to the consumer, the material is pressurized in the direction of the mouth of the discharge line at the collecting container, at the latest after the cartridge is completely emptied, which is preferably done by moving forward a discharge piston guided tightly within the collecting container from an open side in the direction of the mouth of the discharge line, preferably in the direction of the bottom of the mostly pot-shaped collecting container where the mouth is in the bottom.

As the collecting container is filled with material in a vacuum environment and as such a discharge piston is inserted under vacuum into the open upper side of the collecting container, no more gas pockets are formed, even if, after insertion of the discharge piston into the open upper side of the collection container, there still was a clearance between the discharge piston and the upper side of the filling of material, since it no longer contains any air.

Splitting of the material coming out of the removal opening as one thick strand into a plurality of thin strands is carried out by means of a distributing head, which in particular has a plurality of outlet openings for each thin strand. The viscous material is extruded out of the distributing head in the form of the plurality of thin strands. Advantageously, this distribution head, which during emptying of the cartridge is preferably arranged at a distance above the open top of the collecting container, is subsequently used as a discharge piston, especially after completely emptying the cartridge, and is inserted into the collecting container and is tightly guided downwards, for which the distribution head must have suitable dimensioning.

On the one hand, no separate discharge piston is required for this purpose, and on the other hand, it is prevented thereby that a separately existing discharge piston is placed below the distributing head and above the opening of the collecting container and is lowered into it only then, which would be much more time-consuming. Preferably, the distributing head alone is not pushed axially into the collecting container, but rather together with the cartridge, to the front end of the removal opening to which it is attached so that the cartridge thus acts as a plunger that moves the distributing head axially.

Preferably, the cartridge is moved axially by being fixed with its rear end in both axial directions, i.e., both upwards and downwards, in a cartridge carrier and this cartridge carrier can be moved back and forth in a pressing direction by way of a conveying drive.

For pressing the material out of the cartridge, a cartridge plunger of a cartridge drive is fixed to the rear side of the pusher facing away from the material and presses the pusher further forwards in the direction of the removal opening.

To ensure a tight fit of the pusher on the inner circumference of the cartridge, the cartridge can also be supported radially on its outer circumference.

Preferably, the area on the outside, i.e., the back side, of the pusher up to the exit point of the cartridge plunger from the cartridge drive, is kept under negative pressure during the emptying process, so that no air is present on the back side of the pusher that could penetrate the material in case of a possible leak between the pusher and the inner circumference of the cartridge.

Preferably, instead or in addition, only the area on the back side of the cartridge plunger can be evacuated, but not up to its exit point from the cartridge drive, but merely to a front part of the cartridge plunger.

In order to be able to perform emptying, the cartridge with the distributing head already attached to its removal opening is inserted under the retracted cartridge plunger in a direction transverse to the pressing direction and fixed in the cartridge carrier in alignment with the cartridge plunger, the cartridge carrier being displaced, particularly upwards, from the collecting container to such an extent that, in inserting the cartridge into the cartridge carrier, the distributing head is still above the collecting container.

With regard to the novel method, the object is solved in that in pressing out the material from the removal opening by means of axial displacement of a pusher, the material is divided into a plurality of thin strands. As a result of the large increase in surface area achieved by the plurality of thin strands, the probability that a gas bubble in the material coming into contact with the surface of such a thin strand is much higher, and, of course, the thinner the strands are the higher the probability.

The strands are dropped into a collecting container open to the top and mix with the fluid material provided therein, which is delivered from the collecting container to a consumer by way of a main feed pipe connected to the lower part of the container.

In order to prevent new gas pockets from forming when the thin strands are combined with the material in the collecting container, at least the area where the material is divided into a large number of thin strands, i.e., approximately from the removal opening to the upper open end of the collecting container, is held under negative pressure during the emptying process of the cartridge, and preferably also during discharge of the material from the collecting container to a consumer.

The gas contained in an opening gas bubble in the material then is discharged from this area and, if there is nearly a vacuum in the area, no new gas pockets can form.

Negative pressure within the context of the present description is understood to mean that this is in particular approximately a vacuum with a residual pressure of 50 mbar at most, preferably 10 mbar at most, further preferably 1 mbar at most.

For transportation to the consumer the material is pressurized in the direction of the mouth of the discharge line at the collecting container, at the latest after the cartridge is completely emptied, which is preferably done by moving forward a discharge piston guided tightly within the collecting container from an open side in the direction of the mouth of the discharge line, preferably in the direction of the bottom of the mostly pot-shaped collecting container where the mouth is in the bottom.

As the collecting container is filled with material in a vacuum environment and as such a discharge piston is inserted under vacuum into the open upper side of the collecting container, no more gas pockets are formed, even if, after insertion of the discharge piston into the open upper side of the collection container, there still was a clearance between the discharge piston and the upper side of the filling of material, since it no longer contains any air.

Splitting of the material coming out of the removal opening in one thick strand into a plurality of thin strands is carried out by means of a distributing head, which in particular has a plurality of outlet openings for each thin strand.

Advantageously, this distributing head, which during emptying of the cartridge is preferably arranged at a distance above the open top of the collecting container, is subsequently used as a discharge piston, especially after completely emptying the cartridge, and is inserted into the collecting container and is tightly guided downwards, for which the distribution head must have suitable dimensioning.

On the one hand, no separate discharge piston is required for this purpose. On the other hand, it is prevented thereby that a separately existing discharge piston is placed below the distributing head and above the opening of the collecting container and is lowered into it only then, which would be much more time-consuming. Preferably, the distributing head alone is not pushed axially into the collecting container, but rather together with the cartridge, to the front end of the removal opening to which it is attached so that the cartridge thus acts as a plunger that moves the distributing head axially.

Preferably, the cartridge is moved axially by being fixed with its rear end in both axial directions, i.e., both upwards and downwards, in a cartridge carrier and this cartridge carrier can be moved back and forth in a pressing direction by way of a conveying drive.

For pressing the material out of the cartridge, a cartridge plunger of a cartridge drive is fixed to the rear side of the pusher facing away from the material and presses the pusher further forwards in the direction of the removal opening.

To ensure a tight fit of the pusher on the inner circumference of the cartridge, the cartridge can also be supported radially on its outer circumference.

Preferably, the area on the outside, i.e., the back side, of the pusher up to the exit point of the cartridge plunger from the cartridge drive, is kept under negative pressure during the emptying process, so that no air is present on the back side of the pusher that could penetrate the material in case of a possible leak between the pusher and the inner circumference of the cartridge.

Preferably, instead or in addition, only the area on the back side of the cartridge plunger can be evacuated, but not up to its exit point from the cartridge drive, but merely to a front part of the cartridge plunger.

In order to be able to perform emptying, the cartridge with the distributing head already attached to its removal opening is inserted under the retracted cartridge plunger in a direction transverse to the pressing direction and fixed in the cartridge carrier in alignment with the cartridge plunger, the cartridge carrier being displaced, particularly upwards, from the collecting container to such an extent that, in inserting the cartridge into the cartridge carrier, the distributing head is still above the collecting container.

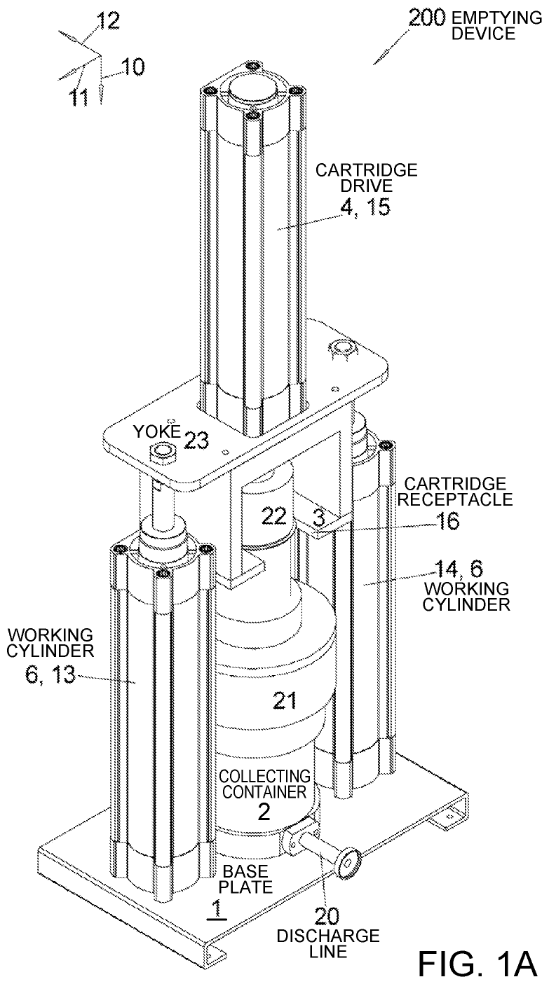

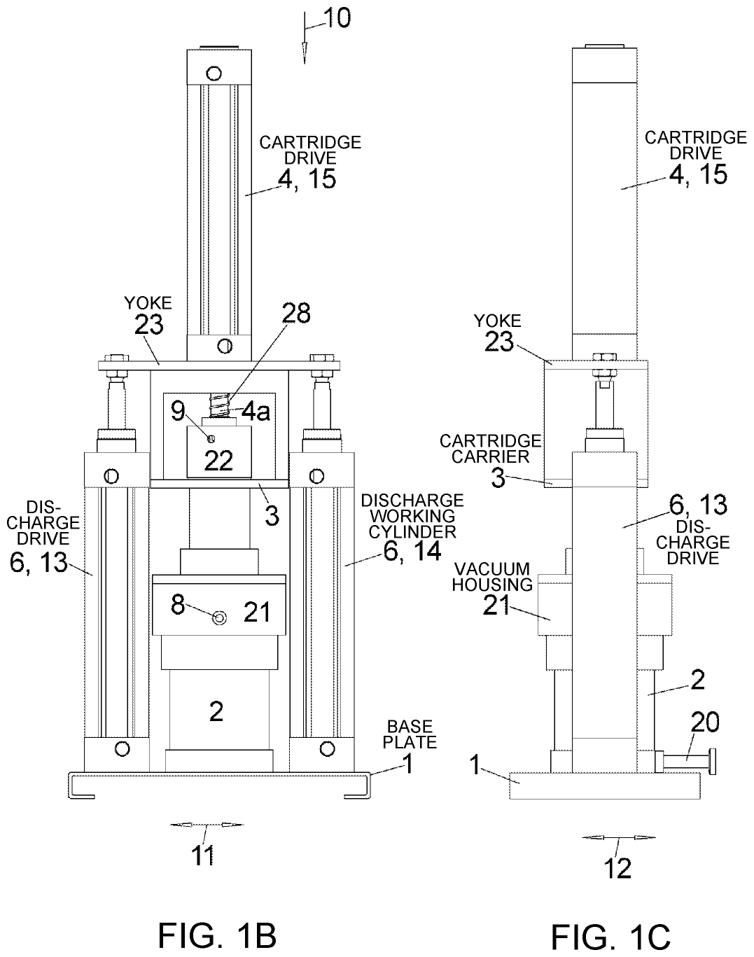

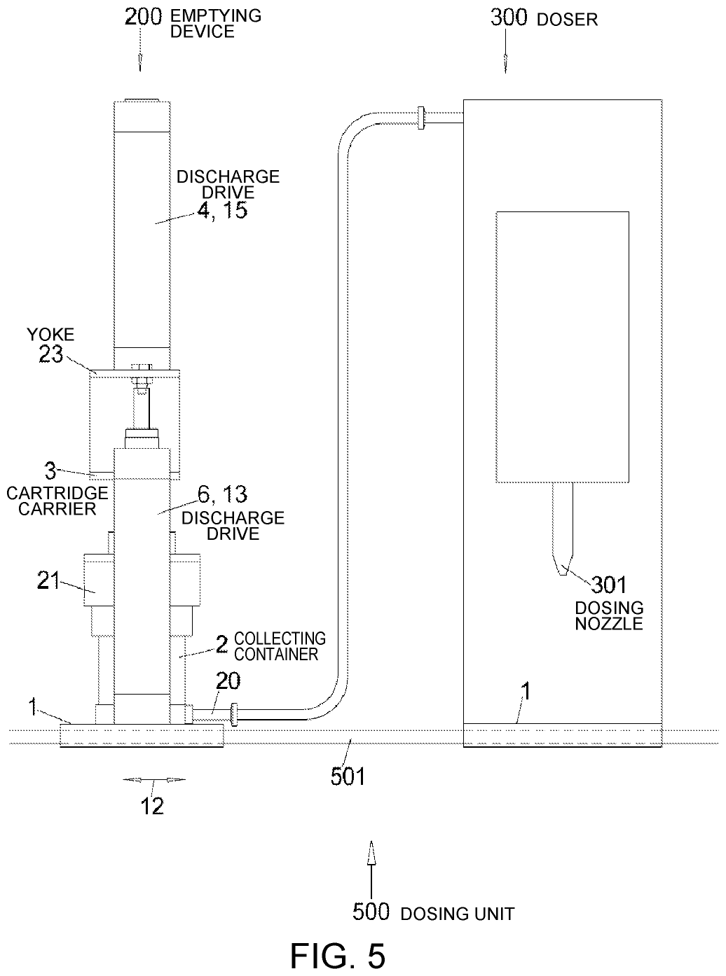

As can be discerned from FIGS. 1A, 1B, 1C, 2A, 2B and 3A, the emptying device 200 includes a base frame 1 in the form of a base plate 1 on which two discharge working cylinders 13, 14 are arranged spaced apart in a first transverse direction 11. The base plate 1 preferably has lateral wheels cranked inwards towards each other in a downward direction for pushing onto a guide 501 in an encompassing manner, as depicted in FIG. 5. In this embodiment, the two discharge working cylinders 13, 14 are in the form of pneumatic cylinders. The two discharge working cylinders 13, 14 together form the discharge drive 6 because they are arranged with their pressing directions 10 in parallel to each other, and the respective piston rod 13a, 14a can be extended vertically upwards from their respective cylinder 13b, 14b.

The upper free ends of these two piston rods 13a, 14a, which can be moved synchronously, are connected to each other by a yoke 23, on which the cartridge drive 4 in the form of preferably only one cartridge working cylinder 15 projects centrally, this time with the bottom of cylinder 15b pointing upwards, so that the piston rod 15a as a cartridge plunger 15a extends downwards therefrom and protrudes through an opening in the yoke 23, which is formed in the cartridge receptacle 16 of cartridge carrier 3, into a cartridge 100 suspended therein and aligns therewith.

In this case, the cartridge carrier 3 consists of a rectangular profile open in the second transverse direction 12 on at least one side, preferably continuously, which is preferably attached to the underside of the yoke 23, which is narrow enough in the first transverse direction 11 to dip between the two discharge working cylinders 13, 14.

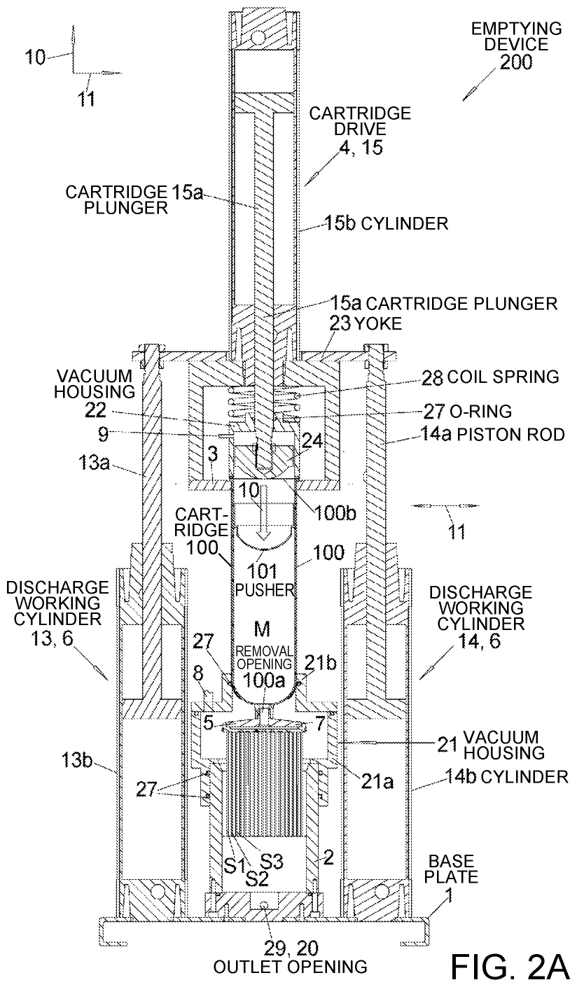

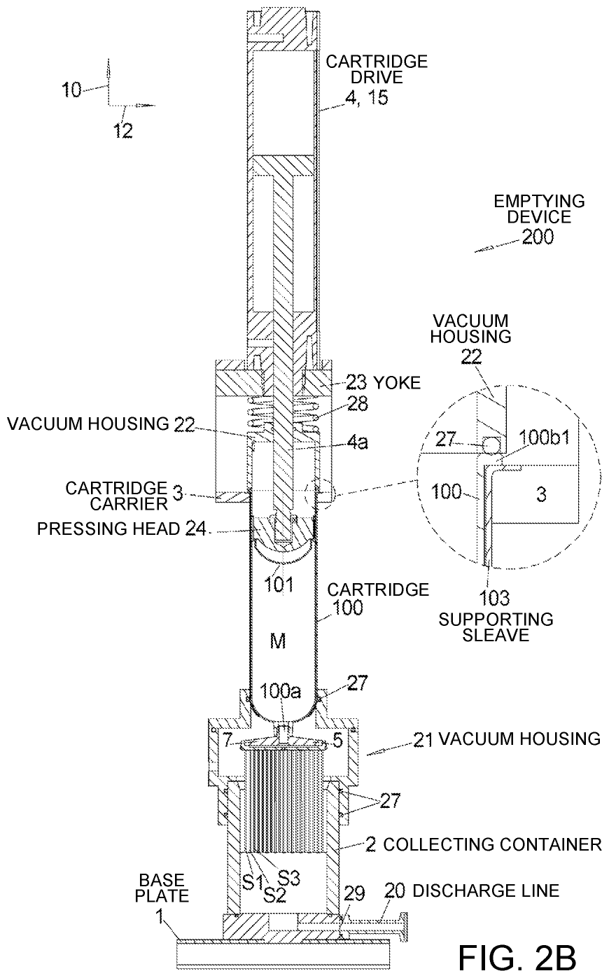

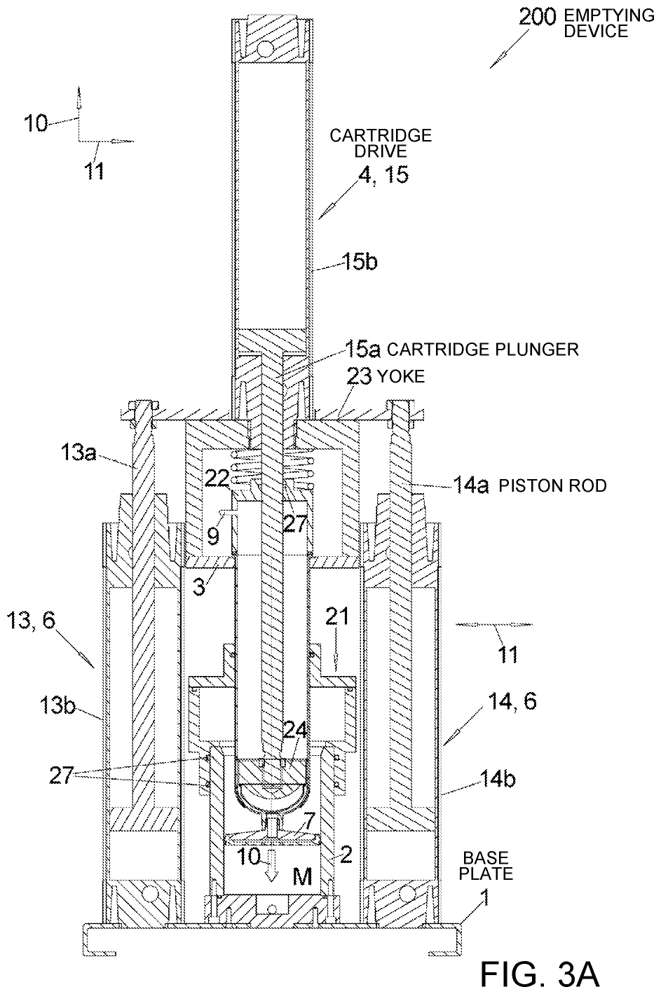

Thereby, in the lower horizontal plate of the rectangular profile, there is a recess in the second transverse direction 12 (see FIG. 1A) that is open, U-shaped and continuous from top to bottom and that is dimensioned such that a cartridge 100 with its outwardly pointing edge 100b1 running around the filling opening 100b can be hooked into it by inserting the cartridge 100 into the cartridge receptacle 16 in the second transverse direction 12 in such a way that the cartridge, with the filling opening 100b pointing upward with this upper edge 100b1, rests on cartridge carrier 3, i.e., on the edge portion thereof running around the cartridge receptacle 16, and is held in place preferably with the aid of a fixing device 3a, as represented in the enlargement of FIG. 2B.

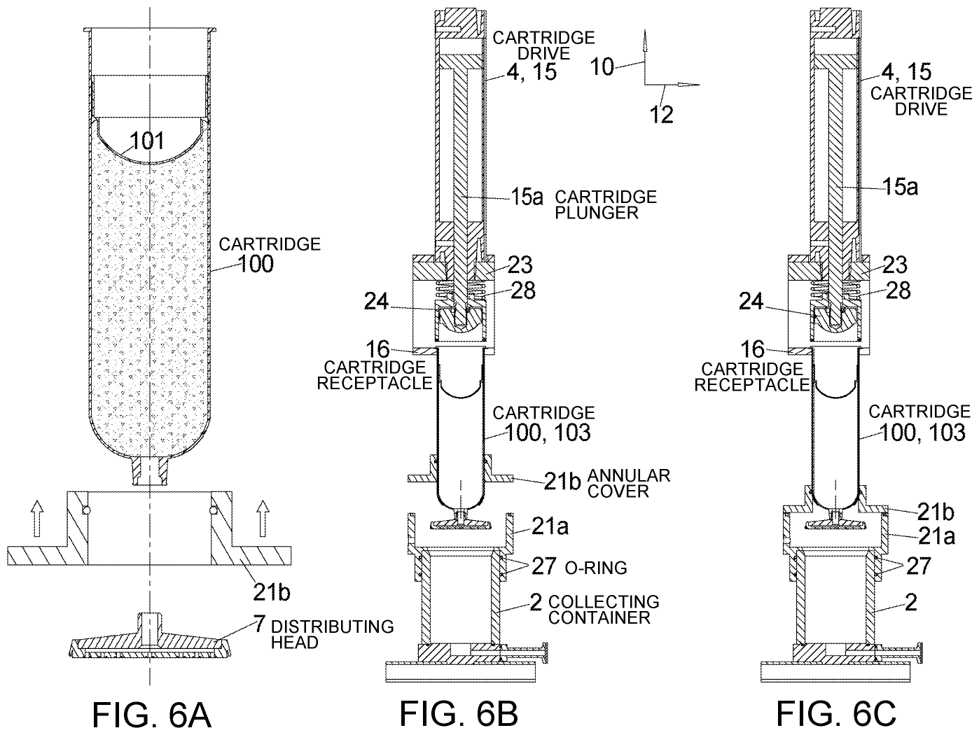

The cartridge insertion process will be described later by way of FIGS. 6A, 6B and 6C.

In this suspended state, the cartridge 100 extends through the cartridge receptacle 16 and points downward with its generally smaller removal opening 100a at the opposite end.

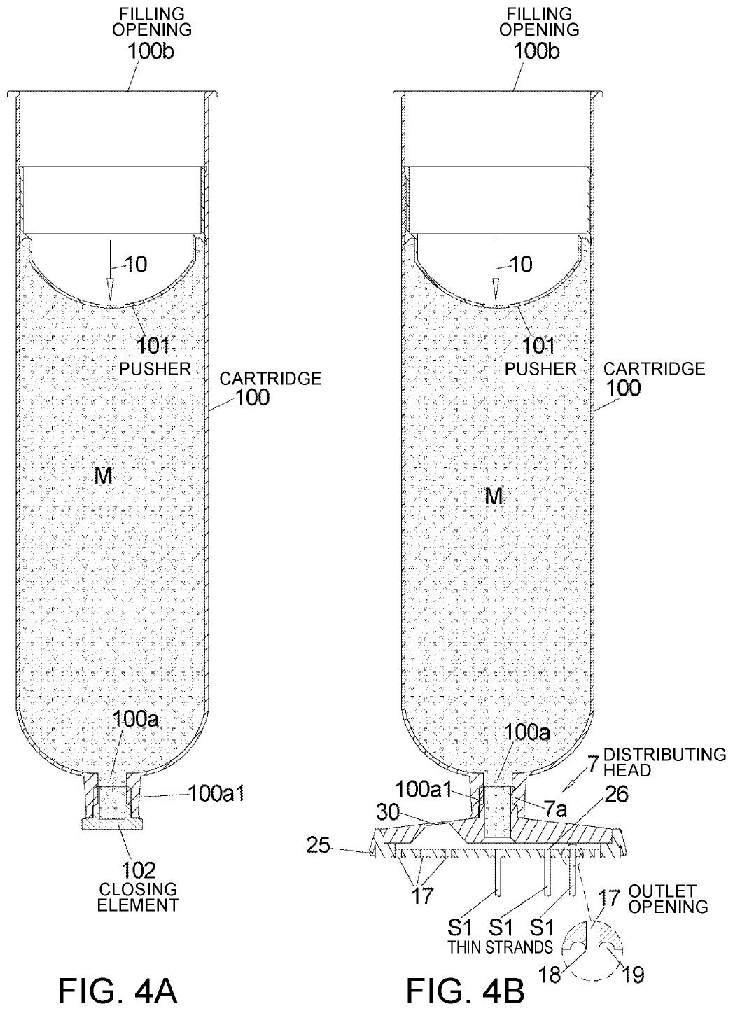

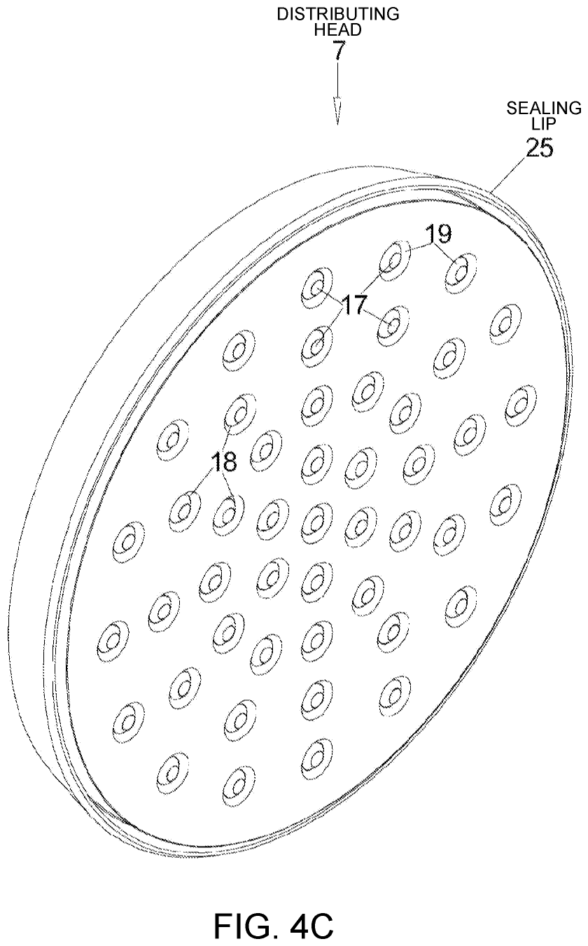

As depicted in FIG. 4A, the removal opening 100a is closed in the transport state by a closing element, usually a locking screw 102 that can be screwed onto the thread, in particular internal thread 100a1 of removal opening 100a, and a pot-shaped pusher 101 inserted into the opposite filling opening 100b abuts tightly on the inner circumference of the cartridge 100, the friction of which, by way of contrast, being so large that automatic moving out of the filling opening 100b is not possible, not even by the material present between the pusher 101 and the closing element 102.

For emptying, in accordance with the invention, the closing element 102 is removed and instead a distributing head 7 is screwed to the removal opening 100a, preferably with its own thread, in particular an external thread, as a fastening device 7a to the thread, in particular internal thread 100a1, which will be explained later.

In FIGS. 1A, 1B, 1C, 2A, 2B, 3A and 3B, the cartridge is already equipped with such a distributing head 7 which, viewed from above, has a greater transverse extension, in particular a larger diameter, than the cartridge 100.

On the base frame 1, in particular on the base plate 1, a collecting container 2 is mounted between the two discharge working cylinders 13, 14 and in alignment with the cartridge working cylinder 15, which likewise is operated pneumatically, and the cartridge 100 firmly held in the cartridge receptacle 16.

The distributing head 7 fits tightly into the pot-shaped collecting container 2 open at the top.

The yoke 23 can be raised sufficiently so that the distributing head 7 is above the collecting container 2, and lowered enough so that the distributing head 7 rests on the bottom of the collecting container 2.

The piston rod, i.e., the cartridge plunger 15a, of the cartridge working cylinder 15 carries a pressing head at its lower free end, the downwardly facing end face of which is adapted to the concave curvature of the upper side of the pusher 101 and fits into the latter.

The cartridge working cylinder 15 is dimensioned in such a way that, when the piston rod 15a is fully retracted into its cylinder 15b, i.e., raised, the pressing head 24 is located at a height fully above the suspended cartridge 100 and, in the fully extended state, is close to the bottom of the cartridge 100 at its removal opening 100a, with only the pot-shaped pusher 101 in between.

In the lower region of the emptying device 200, preferably in the bottom of the collecting container 2, an outlet opening 29 is provided, which is connected to a discharge line 20 leading to a remote consumer for the material M.

For feeding material M from the cartridge 100 to the discharge line 20 and thus to the consumer, a cartridge 100 must first be installed in the emptying device as shown in FIG. 2A.

For this purpose (see FIGS. 6A, 6B and 6C) the cartridge 100 is first prepared as shown in FIG. 6A by optionally first pushing a circumferentially closed support sleeve 103, which abuts on the outer circumference of the cartridge 100, from its lower end on the emptying side on the cartridge, which also has an edge projecting radially outwards at the upper end, up to the edge 100b1 of the cartridge 100, the supporting sleeve 103 then extending downwards preferably over the entire cylindrical part of the cartridge 100.

Subsequently, the annular cover 21b of a first vacuum housing 21 is pushed from the emptying end onto the outer circumference of the cartridge 100 or—if provided—of the support sleeve 103 to such an extent that the distributing head 7 can then be attached to the lower removal opening 100a, in particular can be screwed into the internal thread 100a1 thereof. This sequence is necessary because the outer circumference of the distribution head 7 is larger than the outer circumference of the cartridge 100 and also the inner circumference of the annular cover 21b.

Then the cartridge 100, if necessary along with surrounding support sleeve 103 as well as cover 21b and distributing head 7, is pushed into the cartridge receptacle 16 in the second transverse direction 12 and, by means of the fixing device 3a, the edge 100b1 and possibly the edge of the supporting sleeve 103 located beneath, are pressed firmly onto the upper side of the cartridge receptacle 16, these parts preferably being sealed off from one another by means of concentric circumferential O-rings 27.

FIG. 6B shows how the cartridge plunger 15a is moved back upwards to such an extent that the pressing head attached to it and the bell-shaped second vacuum housing 22 slipped over it from above are located above the upper side of the cartridge receptacle 16 to such an extent that an insertion of the cartridge 100 in the second transverse direction 12 is possible. In this case, the two discharge working cylinders 13, 14 are extended with regard to their piston rods 13a, 14a to such an extent that the distributing head 7 fastened to the cartridge 100 is then in a position above, but aligned vertically with the collecting container 2.

Subsequently, in FIG. 6C, the cover 21b is moved downward and connected tightly to the upper side of the sleeve-shaped lower part 21a of the first vacuum housing 21, whereby the cover 21b still sits close to the outer circumference of cartridge 100 or support feet 103, sealed by means of an O-ring 27, for example. Alternatively, the sleeve-shaped lower part 21a can be moved upwards along the outer circumference of the collecting container 2 until it reaches the lid 21b and can then be tightly connected to it. Based on this hanging position shown in FIG. 6C, the piston rod 15a of the cartridge drive 4, which constitutes the cartridge working cylinder, is first moved downwards to such an extent that the pressing head 24 dips into the cartridge 100 and rests against the upper side of the pusher 101.

By this, the cartridge 100 is fixed in all horizontal directions, so that this represents a first part of the fixing device 3a, and at the latest when the pressing head 24 dips into the cartridge 100, the pressing piston is released from the bottom of the second, pot-shaped vacuum housing 22, so that the latter with its lower annular edge representing the second part of the fixing device 3a is pressed downwards onto the laterally projecting edge 100b1 by way of a coil spring 28, which is concentrically arranged around the piston rod 15a between the second vacuum housing 22 and the yoke 23, more precisely, at the upper side of the cartridge carrier 3, which is rectangular in the side view.

When the pressing head 24 is then moved further downward as shown in FIGS. 2A and 2B, it pushes the pusher 101 downward in front of it, whereby the material M in the cartridge 100 is pressed out downward via the removal opening 100a and the distribution head 7 attached thereto, and falls into the collecting container 2, which preferably has a volume such that it can receive the entire filling of cartridge 100.

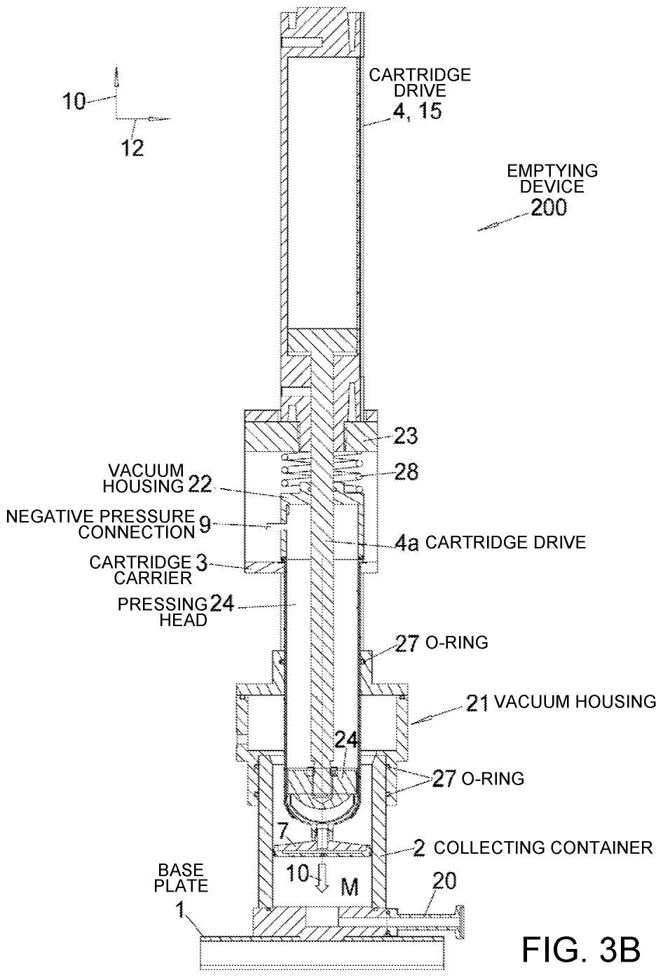

As soon as the pusher 101 has reached the lower end of the cartridge 100 on the removal side and the cartridge 100 is empty, the piston rods 13a, 14a of the two working cylinders 13, 14 are synchronously retracted downwards into the cylinders 13b, 14b, as shown in FIGS. 3A and 3B, so that the yoke 23 with all parts attached to it, i.e., both the cartridge carrier 3 and the cartridge 100 and the pressing head located in its lower area, move downwards together, whereby first the distributing head 7 moves into the open upper end of the collecting container 2, the inner circumference of which is widened conically towards the top at the upper end to facilitate retraction, and with its circumferential sealing lip 25 tightly fitting against its inner circumference, moves further downward, apriori until the distributing head 7 is seated on the material M in the collecting container.

By moving even further down, the distributing head 7, acting as a discharge piston 5, pushes the material down out of the collection container 2 into the discharge line 20 and thus to the remote consumer.

According to the invention, the material M is thereby degassed as follows. As depicted in perspective in FIG. 4C, the object of the distribution head is to divide the material M exiting through the discharge opening 100a in a single thick strand and entering the upper side of the internally hollow distributing head 7, into a plurality of thin strands S1, S2, S3, in that in the lower side of the distributing head 7, a plurality of outlet openings 17 of a comparatively small diameter are arranged.

So that the strands S1, S2, S3 exit from those outlet openings 17 downwards in a straight line, a sharp tear-off edge 18 is formed around each outlet opening 17, which is achieved, for example, by arranging an annular groove 19 around each outlet opening 18 in the generally flat lower side of the distributing head 7, which, together with the inner circumference of the outlet opening 17, forms the circumferential, sharp, i.e., acute-angled, tear-off edge 18.

As a result, the strands S1, S2 fall downwards into the collecting container 2 in parallel instead of being deflected laterally, as is possible with one-sided adhesion and very quickly combining again with neighboring strands S2, S3, for this large surface area, which is maintained as long as possible on the thin strands S1, S2, S3, is required in order to open gas pockets existing in the strand and allow the gas to escape.

In this case, the distributing head 7 is located above the collecting container 2, which is why it is necessary for the strands S1, S2, S3 to fall downwards in straight lines.

In order to prevent air from the environment from entering the material M again when the material is pressed out and collected in the collecting container 2, a first vacuum is formed around it.

For this purpose, the first vacuum housing 21 is provided that is equipped with a negative pressure connection 8 and whose upper, annular cover 21b with its upper through-opening abuts the outer circumference of the cartridge 100 and whose sleeve-shaped lower part 21a with its lower through-opening abuts the outer circumference of the collecting container 2, sealed in each case, for example, via O-rings 27.

To prevent air from being forced past the seal of the pusher 101 into the material M in the cartridge when the press head 24 is inserted into the cartridge 100 when the pressing head 24 is retracted, the bell-shaped second vacuum housing 22, which has its opening facing downwards, is seated on the upper edge 100b1 of the suspended cartridge 100 with its circumferential walls on this edge 100b1.

The cartridge plunger 15a of the cartridge working cylinder 15 can be pushed tightly through an opening in the upwardly facing bottom of the pot-shaped second vacuum housing 22, O-rings 27 preferably being used again for sealing.

Via the negative pressure connection 9 also provided on the vacuum housing 22, air contained therein is extracted as soon as it is seated on the cartridge and even before the pressing head 24 enters the cartridge, for which purpose the second vacuum housing 22 is preferably dimensioned in such a way that the pressing head 24 does not abut tightly on the inner circumference of the pot-shaped second vacuum housing 22.

In order to ensure that any residual air that may still be present between the distributing head 7 and the surface of the material is not pressed into the material M when the distributing head 7 is moved into the collecting container 2, despite there being the first vacuum, a venting valve can be provided in the back side facing away from the material, i.e., the bottom of the collecting container 2, hence the upper side of the distributing head 7, through which air entering the hollow interior of the distributing head 7 via the lower outlet openings 17 would be released upwards into the first vacuum. The venting valve can be a simple diaphragm that is permeable to air but not to the material M to be conveyed. In this way, any air pockets that may still exist in the material M in the cartridge 100 can be removed before the material M reaches the consumer via the discharge line 20.

FIG. 5 shows a dosing unit 500 with a doser 300 with a dosing nozzle 301 through which the viscous material M is dosed out in precisely predetermined quantities. The emptying device 200 is connected to the doser 300 via the discharge line 20. Both the doser 300 and the emptying device 200 preferably have an analogously designed base plate 1 so that both can be slid onto the same guide 501 and positioned at a correct distance from one another.

### REFERENCE NUMERALS

1 base frame, base plate
2 collecting container
3 cartridge carrier
3a fixing device
4 cartridge drive
5 discharge piston
6 discharge drive
7 distributing head
7a fastening device
8 negative pressure connection
9 negative pressure connection
10 pressing direction
11 first transverse direction
12 second transverse direction
13 discharge working cylinder
13a piston rod
13b cylinder
14 discharge working cylinder
14a piston rod
14b cylinder
15 cartridge working cylinder
15a cartridge plunger
15b cylinder
16 cartridge receptacle
17 outlet opening
18 tear-off edge
19 annular groove
20 discharge line
21 1. vacuum housing
22 2. vacuum housing
23 yoke
24 pressing head
25 sealing lip
26 cavity
27 O-ring
28 coil spring
29 outlet opening
30 venting valve, diaphragm
100 cartridge
100a removal opening
100a1 internal thread
100b filling opening
100b1 edge, flange
101 pusher
102 closing element, locking screw
200 emptying device
300 doser
301 dosing nozzle
500 dosing unit
501 guide
M material
S1-S3 strands

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-15. (canceled)

16. A method for emptying viscous material in a bubble-free manner out of a cartridge, comprising:
pushing a pusher axially through the cartridge in a pressing direction towards a removal opening of the cartridge, wherein the pusher fits tightly in the cartridge;
pressing the viscous material out of the removal opening and through a distributing head such that the viscous material is divided into a plurality of thin strands;
collecting the plurality of thin strands in a collecting container, wherein a discharge line is connected to the collecting container; and
maintaining a negative pressure in the collecting container while the plurality of thin strands are being collected in the collecting container.

17. The method of claim 16, wherein the negative pressure is a vacuum with a residual pressure inside the collecting container of at most 50 mbar.

18. The method of claim 16, further comprising:
after the plurality of thin strands have been collected in the collecting container, pressing the viscous material out of the collecting container through the discharge line by pushing the distributing head as a discharge piston axially down into the collecting container.

19. The method of claim 16, wherein the viscous material is divided into the plurality of thin strands as the viscous material exits a plurality of outlet openings in the distributing head.

20. The method of claim 16, wherein the pusher is connected to a cartridge plunger, and wherein a discharge drive drives the cartridge plunger in the pressing direction.

21. The method of claim 16, wherein the distributing head is connected to the cartridge at the removal opening, further comprising:
after the plurality of thin strands have been collected in the collecting container, pressing the viscous material out of the collecting container through the discharge line by pushing the cartridge together with the distributing head in the pressing direction into the collecting container.

22. The method of claim 16, further comprising:
maintaining a negative pressure in the cartridge behind the pusher while the viscous material is being pressed out of the removal opening.

23. An emptying device for emptying a viscous material out of a removal opening of a cartridge, comprising:
a base frame;
a collecting container mounted to the base frame;
a cartridge carrier guided movably in a pressing direction towards the base frame, wherein the cartridge carrier is adapted to hold the cartridge;
a cartridge plunger adapted to push a pusher of the cartridge in the pressing direction;
a discharge drive that drives the cartridge plunger;
a distributing head that divides the viscous material exiting the removal opening into a plurality of thin strands, wherein the distributing head is fastened to the removal opening, and wherein the distributing head is adapted to move axially in the collecting container in the pressing direction; and
a first vacuum housing that connects in an air-tight manner to the collecting container and to an outer circumference of the cartridge even while the cartridge moves relative to the first vacuum housing.

24. The emptying device of claim 23, further comprising:
a second vacuum housing disposed inside the cartridge carrier that connects in an air-tight manner to the outer circumference of the cartridge, wherein the cartridge plunger passes through the second vacuum housing in an air-tight manner.

25. The emptying device of claim 23, wherein the distributing head is configured such that the plurality of thin strands travel downwards in straight lines from the distributing head.

26. The emptying device of claim 23, wherein the distributing head is formed so that it can be attached at a fixed distance to the removal opening of the cartridge.

27. The emptying device of claim 23, wherein the discharge drive is disposed between the cartridge carrier and the base frame, wherein discharge drive portions are arranged on opposite sides of the cartridge carrier, and wherein each of the discharge drive portions includes a discharge working cylinder.

28. The emptying device of claim 23, further comprising:
a cartridge working cylinder, wherein the cartridge plunger moves axially within the cartridge working cylinder.

29. The emptying device of claim 23, wherein the cartridge can be inserted into the cartridge carrier laterally from the side.

30. The emptying device of claim 23, wherein the cartridge plunger passes through a second vacuum housing, wherein a coil spring is disposed above the second vacuum housing, and wherein the coil spring is used to maintain an air-tight connection between the second vacuum housing and the cartridge.

31. The emptying device of claim 23, wherein the emptying device is connected to a doser for dosing the viscous material.

32. A method for emptying viscous material out of a cartridge, comprising:
pushing a cartridge plunger axially into the cartridge, wherein the cartridge plunger is attached to a pusher that fits tightly in the cartridge, and wherein the viscous material is disposed between the pusher and a removal opening in the cartridge;
pushing the viscous material out of the removal opening, wherein a distributing head is coupled to the removal opening;
pushing the viscous material out through the distributing head such that the viscous material is divided into a plurality of thin strands;
collecting the plurality of thin strands in a collecting container;
maintaining a vacuum in the collecting container while the plurality of thin strands are being collected in the collecting container; and
after the plurality of thin strands have been collected in the collecting container, pushing the viscous material out of the collecting container through a discharge line by pushing the distributing head axially downwards into the collecting container such that the viscous material is forced out through the discharge line.

33. The method of claim 32, further comprising:
maintaining a vacuum in the cartridge behind the pusher while the viscous material is being pushed out of the removal opening.
